(19) United States
(12) Patent Application Publication
(10) Pub. No.: US 2024/0029595 A1
(43) Pub. Date: Jan. 25, 2024

(54) SYSTEMS, METHODS, AND DEVICES FOR MAKING A THREE-DIMENSIONAL DESIGN

(71) Applicant: Diodify, LLC, Frisco, TX (US)

(72) Inventors: James Boros, Colleyville, TX (US); Kelly Blackwood Carter, Colleyville, TX (US)

(73) Assignee: Diodify, LLC, Frisco, TX (US)

(21) Appl. No.: 18/337,836

(22) Filed: Jun. 20, 2023

Related U.S. Application Data
(60) Provisional application No. 63/353,289, filed on Jun. 17, 2022.

(51) Int. Cl. G09F 13/18; G09F 13/04; G09F 13/20

(52) U.S. Cl. CPC G09F 13/18; G09F 13/049; G09F 13/20

(57) ABSTRACT

Systems, methods, and devices for making a three-dimensional design are disclosed. The method includes generating a base layer with a three-dimensional feature by removing material from a starting block. Then a cover layer is generated with an opening having a shape that corresponds to the three-dimensional feature. The cover layer is coupled (e.g., adhered) to a first front surface of the base layer by inserting the three-dimensional feature into the opening. The three-dimensional feature extends past a plane defined by a second front surface of the cover layer such that a side surface of the three-dimensional feature is exposed. A light fixture is positioned adjacent to a back surface of the base layer, such that the three-dimensional feature is illuminated through the opening. A top surface of the three-dimensional feature is covered, such that light only transmits through the side surface of the three-dimensional feature, creating a backlighting effect.

### CROSS REFERENCE TO RELATED APPLICATIONS

This application claims priority to U.S. Provisional Patent Application No. 63/353,289, filed Jun. 17, 2022 and titled “SYSTEMS, METHODS, AND DEVICES FOR MAKING A THREE-DIMENSIONAL DESIGN,” the entirety of which is incorporated by reference herein.

### BACKGROUND

A typical process for forming a sign can include cutting a piece of material in its original form and thickness. Then a second piece of material is attached to the top. with a cutout for backlight. These processes result in a flat finish. Techniques for creating three-dimensional finishes cost more, take more time, and require additional materials and experience. It is with these observations in mind that the present technology was conceived.

### BRIEF SUMMARY

Systems methods, and devices for addressing the aforementioned issues are disclosed herein. For example, a method of forming a three-dimensional sign can include generating a base layer with a three-dimensional feature by removing material from a starting block to define the three-dimensional feature; generating a cover layer with an opening having a shape that corresponds to the three-dimensional feature; and/or coupling the cover layer to a first front surface of the base layer by inserting the three-dimensional feature into the opening, the three-dimensional feature extending past a plane defined by a second front surface of the cover layer.

In some examples, the method further includes positioning a light fixture adjacent to a back surface of the base layer; and/or providing electricity to the light fixture such that the three-dimensional feature is illuminated through the opening. Moreover, the cover layer can form an opaque layer, and illumination of the light fixture is partially blocked by the opaque layer. The three-dimensional feature can include a side surface that extends past the plane defined by the second front surface of the cover layer; and/or the illumination of the light fixture can transmit out the side surface of the three-dimensional feature onto the second front surface of the cover layer. Additionally, the starting block is a single starting block; and/or the method can further include generating a plurality of three-dimensional features at the first front surface of the base layer by removing the material from the single starting block with a routing machine during a single routing machine usage. The starting block can also be an acrylic sheet having a thickness dimension between ¼ inch and two inches. In some scenarios, the acrylic sheet has a width dimension of four feet and a length dimension of eight feet. Additionally or alternatively, the cover layer can be formed of aluminum or laminated wood.

In some instances, the cover layer includes a translucent or opaque paint; and/or coupling the cover layer to the first front surface of the base layer includes applying the translucent or opaque paint to the first front surface at one or more locations surrounding the three-dimensional feature. Generating the base layer can also include removing the material with a routing machine. The base layer can be formed of acrylic, wood, or plastic. Moreover, the three-dimensional feature can include at least one of a circular profile, a rectangular profile, a square profile, or an alphanumeric symbol profile.

In some examples, a method of forming a three-dimensional sign includes generating a base layer with a three-dimensional feature by removing material from a starting block to define the three-dimensional feature; generating a cover layer with an opening having a shape that corresponds to the three-dimensional feature; coupling the cover layer to a first front surface of the base layer by inserting the three-dimensional feature into the opening, the three-dimensional feature extending past a plane defined by a second front surface of the cover layer; positioning a light fixture adjacent to a back surface of the base layer; and/or providing electricity to the light fixture such that the three-dimensional feature is illuminated through the opening.

In some instances, the method can also include at least partially blocking an illumination of the light fixture with the cover layer; and/or at least partially transmitting the illumination from the light fixture out a side surface of the three-dimensional feature onto the second front surface of the cover layer. The method can also include generating a plurality of three-dimensional features at the first front surface of the base layer by removing the material with a routing machined during a single routing machine usage. Furthermore, generating the base layer can include removing the material with a computer numerical control (CNC) machine. Additionally, the base layer can be formed of a transparent or translucent acrylic; and/or the cover layer can be formed of an opaque material. Coupling the cover layer to the first front surface of the base layer can also include applying an adhesive to the cover layer or the base layer to bind the cover layer to the first front surface of the base layer.

In some examples, a method of forming a three-dimensional sign includes generating a base layer with a three-dimensional feature by removing material from a starting block to define the three-dimensional feature; generating a cover layer with an opening having a shape that corresponds to the three-dimensional feature; adhering a first back surface of the cover layer to a first front surface of the base layer by inserting the three-dimensional feature into the opening, the three-dimensional feature having one or more side surfaces extending past a plane defined by a second front surface of the cover layer; positioning a light fixture adjacent to a second back surface of the base layer; and/or providing electricity to the light fixture such that an illumination of the light fixture passes through the three-dimensional feature and out the one or more side surfaces of the three-dimensional feature onto the second front surface of the cover layer.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

The foregoing summary, as well as the following detailed description, will be better understood when read in conjunction with the appended drawings. For the purpose of illustration, there is shown in the drawings certain embodiments of the disclosed subject matter. It should be understood, however, that the disclosed subject matter is not limited to the precise embodiments and features shown. The accompanying drawings, which are incorporated in and constitute a part of this specification, illustrate an implementation of systems, methods, and devices consistent with the disclosed subject matter and, together with the description, serves to explain advantages and principles consistent with the disclosed subject matter, in which:

FIG. 1A illustrates an example system including a three-dimensional sign and corresponding manufacturing techniques.

FIG. 1B illustrates an example system including a three-dimensional sign and corresponding manufacturing techniques.

FIG. 10 illustrates an example system including a three-dimensional sign and corresponding manufacturing techniques.

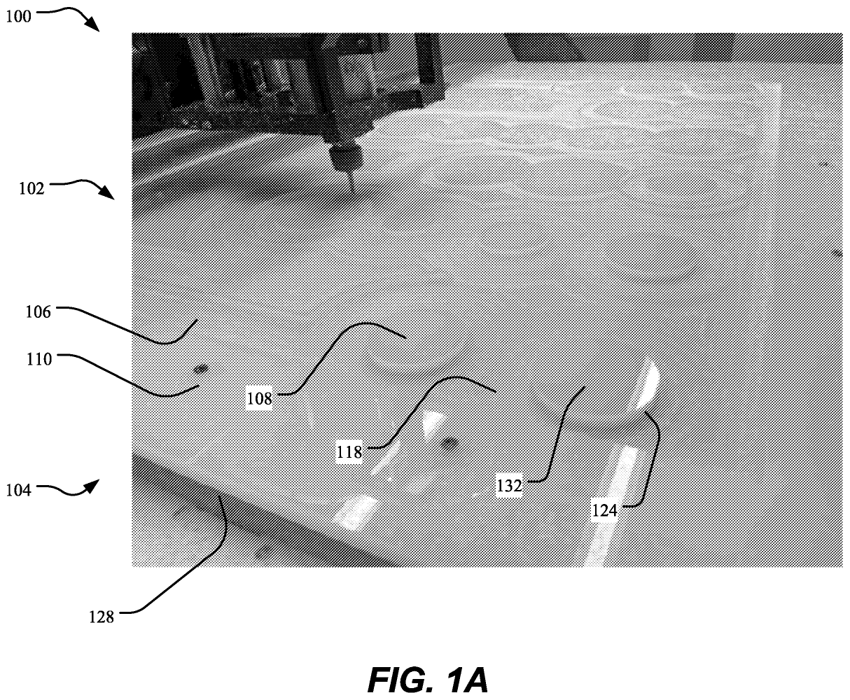

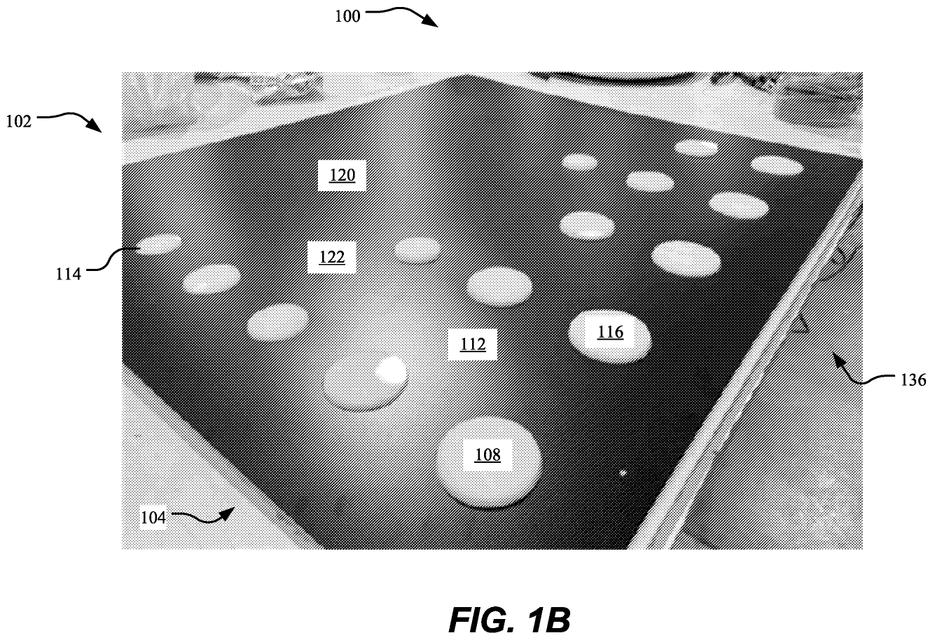

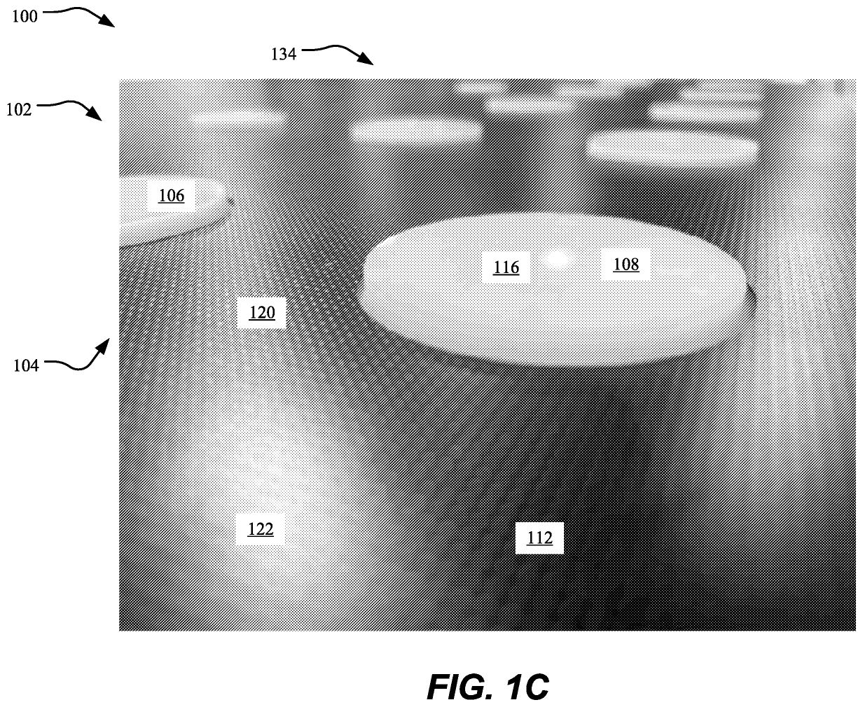

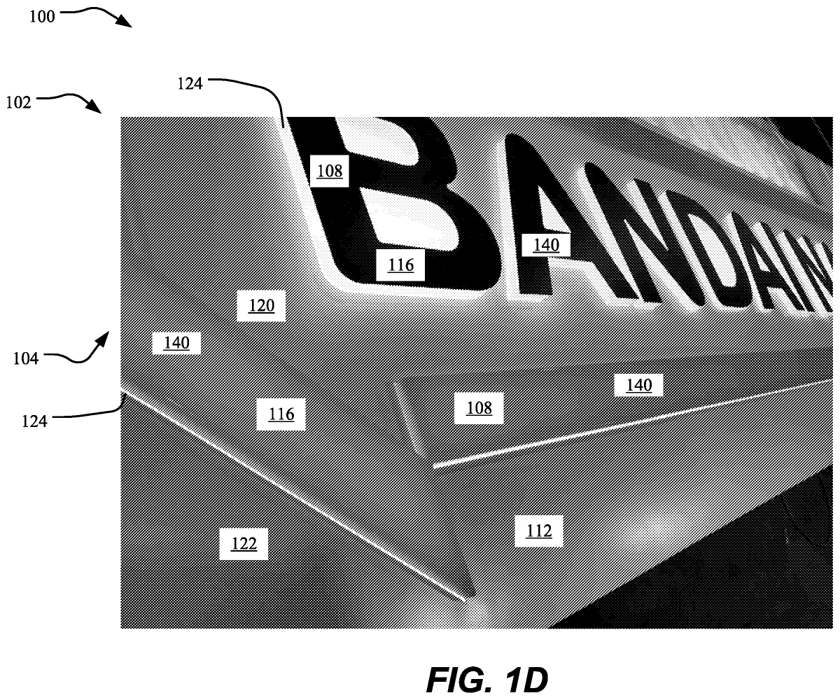

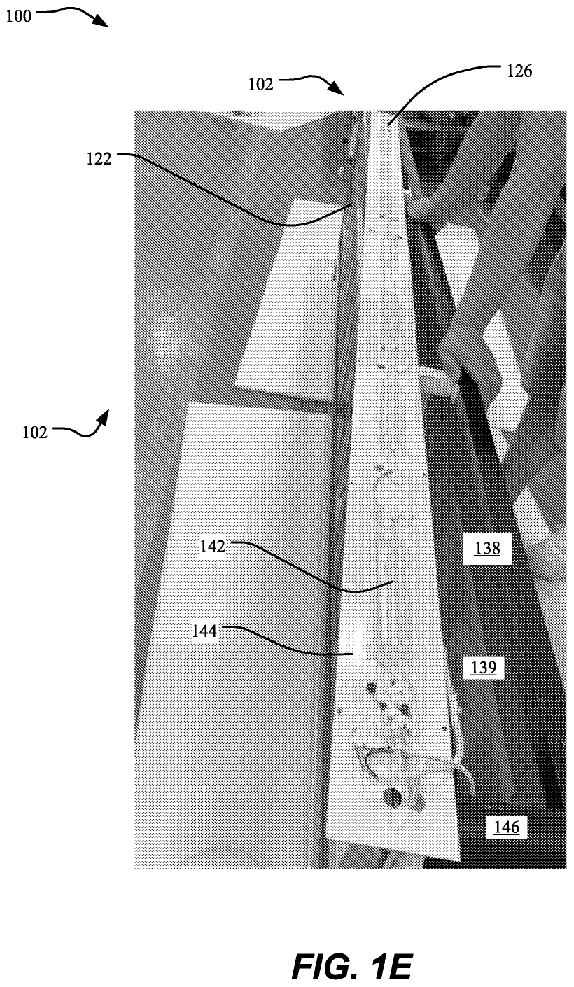

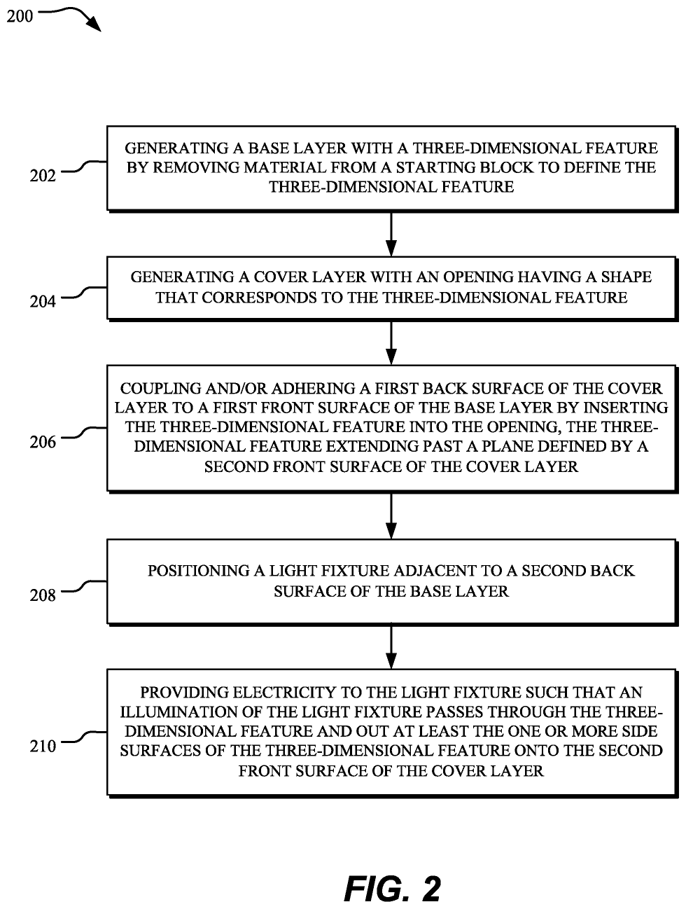

FIG. 1D illustrates an example system including a three-dimensional sign and corresponding manufacturing techniques.

FIG. 1E illustrates an example system including a three-dimensional sign and corresponding manufacturing techniques.

FIG. 2 illustrates an example method of forming a three-dimensional sign, which can be performed by the systems depicted in FIGS. 1A-1E.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The phraseology and terminology employed herein are for the purpose of description and should not be regarded as limiting. For example, the use of a singular term, such as, “a” is not intended as limiting of the number of items. Also, the use of relational terms such as, but not limited to, “top,” “bottom,” “left,” “right,” “upper,” “lower,” “down,” “up,” and “side,” are used in the description for clarity in specific reference to the figures and are not intended to limit the scope of the presently disclosed technology or the appended claims. Further, it should be understood that any one of the features of the presently disclosed technology may be used separately or in combination with other features. Other systems, methods, features, and advantages of the presently disclosed technology will be, or become, apparent to one with skill in the art upon examination of the figures and the detailed description. It is intended that all such additional systems, methods, features, and advantages be included within this description, be within the scope of the presently disclosed technology, and be protected by the accompanying claims.

Further, as the presently disclosed technology is susceptible to embodiments of many different forms, it is intended that the present disclosure be considered as an example of the principles of the presently disclosed technology and not intended to limit the presently disclosed technology to the specific embodiments shown and described. Any one of the features of the presently disclosed technology may be used separately or in combination with any other feature. References to the terms “embodiment,” “embodiments,” and/or the like in the description mean that the feature and/or features being referred to are included in, at least, one aspect of the description. Separate references to the terms “embodiment,” “embodiments,” and/or the like in the description do not necessarily refer to the same embodiment and are also not mutually exclusive unless so stated and/or except as will be readily apparent to those skilled in the art from the description. For example, a feature, structure, process, step, action, or the like described in one embodiment may also be included in other embodiments, but is not necessarily included. Thus, the presently disclosed technology may include a variety of combinations and/or integrations of the embodiments described herein. Additionally, all aspects of the present disclosure, as described herein, are not essential for its practice. Likewise, other systems, methods, features, and advantages of the presently disclosed technology will be, or become, apparent to one with skill in the art upon examination of the figures and the description. It is intended that all such additional systems, methods, features, and advantages be included within this description, be within the scope of the presently disclosed technology, and be encompassed by the claims.

Any term of degree such as, but not limited to, “substantially,” as used in the description and the appended claims, should be understood to include an exact, or a similar, but not exact configuration. For example, “a substantially planar surface” means having an exact planar surface or a similar, but not exact planar surface. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

The term “coupled” is defined as connected, whether directly or indirectly through intervening components, and is not necessarily limited to physical connections. The connection can be such that the objects are permanently connected or releasably connected. The terms “comprising,” “including” and “having” are used interchangeably in this disclosure. The terms “comprising,” “including” and “having” mean to include, but not necessarily be limited to the things so described. The term “real-time” or “real time” means substantially instantaneously.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

FIGS. 1A-1E illustrate an example system 100 for creating a three-dimensional design 102, such as a three-dimensional sign 104 or artwork, including a base layer 106 with a three-dimensional feature 108. The three-dimensional feature 108 can be defined by removing material from a starting block 110 (e.g., using a computer numerical control (CNC) machine). The three-dimensional sign 104 can include a cover layer 112 with an opening 114 having a shape 116 that corresponds to the three-dimensional feature 108. The cover layer 112 can be coupled (e.g., adhered with an adhesive) to a first front surface 118 of the base layer 106. The three-dimensional feature 108 can be inserted into the opening 114 and, upon coupling the cover layer 112 to the three-dimensional sign 104 can extend through the opening 114. The three-dimensional feature 108 can protrude through the opening 114 past a plane 120 defined by a second front surface 122 of the cover layer 112. As such, the three-dimensional feature 108 can have one or more side surfaces 124 that also extend past the plane 120 defined by the second front surface 122 of the cover layer 112.

In some examples, the three-dimensional sign 104 is a backlit three-dimensional sign. For instance, the three-dimensional sign 104 can include a light fixture 126 attached to or otherwise positioned adjacent to a back surface 128 of the base layer 106. Electricity provided to the light fixture 126 (e.g., via a battery source and/or AC source) can cause the light fixture 126 to illuminate. An Illumination of light from the light fixture 126 can illuminate the base layer 106, including the three-dimensional feature 108 protruding from the base layer 106. The illumination of light can transmit through the three-dimensional feature 108 out the first front surface 118 of the three-dimensional sign 104. In some instance, the illumination of light can transmit out one or more sides 124 of the three-dimensional feature 108 and onto a second front surface 122 of the cover layer 112 (e.g., due to the three-dimensional feature 108 extending past the plane 120 defined by the cover layer 112). In some instances, the three-dimensional feature 108 can have a circular profile 132, and the opening 114 can also have a circular profile 132, and/or with a slightly larger diameter, such that a shape of the opening 114 corresponds to a shape of the three-dimensional feature 108.

In some scenarios the three-dimensional feature 108 can include an array of features 134, such as an array of a plurality of circular protrusions 136, a plurality of square protrusions, an array of triangular protrusions, and so forth. The array can be formed of a plurality of rows and columns of the protrusions.

Moreover, as shown in FIG. 1D, the three-dimensional feature 108 can include a text, a graphic design, and/or a combination of various different three-dimensional features 108. In some examples, a top surface 140 of the three-dimensional feature 108 can receive a top cover (e.g., paint, vinyl, or other opaque layer) to block or at least partially block light from transmitting through the top surface 140 of the three-dimensional feature 108, such that light only transmits out the one or more side surfaces 124. Multiple different top surfaces 140 can have top covers of different colors (e.g., red, black, blue, green, yellow, etc.) to form a multi-colored sign having multi-colored three-dimensional feature 108. In this way, the three-dimensional sign 104 can create an even back-lighting illumination effect with light transmitting out from behind the three-dimensional features 108 using a lower cost manufacturing technique.

In some instances, a structure created using the techniques disclosed herein is a three-dimensional design 102 which is routed out of a single piece of material such as but not limited to acrylic, wood, and/or plastics. Once routed down, a three-dimensional feature 108 or design can emerge from the portion of the starting block (e.g., base layer 106) which is not routed. The three-dimensional feature 108 can be surrounded by a second piece of material such as but not limited to: aluminum, vinyl, paint, plastic, metal, laminated wood, and so forth to form the cover layer 112. This can be cladding over the routed portion of the starting block base layer 106. The cladding can be penetrated by the three-dimensional feature 108. In some instances, the three-dimensional design 102 is a finished product that can be backlit or non-backlit. In some instances, the techniques discussed herein create the three-dimensional design 102 using a faster and more cost-effective process to produce, for instance, a sign or artwork. The process can include routing a single piece of material to penetrate through another material forming the cover layer 112, which can be opaque, and/or formed by black paint being painted (e.g., or other opaque material) over certain portions of the base layer 106 and/or the top surfaces 140 to create the three-dimensional sign 104. As such, the final product can have a three-dimensional finish, which can improve light transmission from the backlight.

In some examples, the starting block from which the base layer 106 is routed is a 4′ w×8′ T×½″ thick acrylic sheet. The cover layer 112 can be a black laminate and/or can include a texture. The top cover over the top surfaces 140 can be paint and/or vinyl.

In some examples, other processes do not provide a 3-Dimensional finish. They may, rather, include a flat finish (e.g., with a top surface of the three-dimensional feature 108 substantially even or flush with the plane 120 of the second front surface 122). Other processes for forming a three-dimensional finish may cost more, take longer and require more material and experience. Furthermore, other processes may not route out the back layer to form a portion that penetrates the top material or paint to provide a three-dimensional design. As such, these techniques and material characteristics can provide for a three-dimensional design 102 with a faster manufacturing time, reduced cost, a reduced number of people and/or a reduced experience needed to manufacture.

Turning to FIG. 1E, the three-dimensional design 102 can include a back cabinet 138 for holding and/or mounting the light fixture 126. The back cabinet 138 can include a profile with a front face corresponding to an outer perimeter of the base layer 106. As such, the back cabinet 138 can provide a mounting surface to which the base layer 106 attaches. Furthermore, the back cabinet 138 can define an interior space for receiving the light fixture 126, as well as an interior surface 139 to which the light fixture 126 attaches. In some instances, the back cabinet 138 has a rectangular prism shape. Additionally or alternatively, the light fixture 126 can include one or more elongated lights 142 (e.g., LED strips, fluorescent lights, and so forth) daisy chained together and/or coupled to a light mounting surface 144. The light mounting surface 144 can be a planar sheet which couples to one of the interior surfaces 139 to secure the light fixture 126 in place in the back cabinet 138 and/or behind the base layer 106. The back cabinet 138 can have a top portion 146 for mounting or hanging the three-dimensional sign 104, for instance, with one or more hooks or loops extending from the top portion 146.

FIG. 2 illustrates an example method 200 for forming a three-dimensional sign, which can be performed by any of the system(s) depicted in FIGS. 1A-1E.

In some instances, at operation 202, the method 200 can generate a base layer with a three-dimensional feature by removing material from a starting block to define the three-dimensional feature. At operation 204, the method 200 can generate a cover layer with an opening having a shape that corresponds to the three-dimensional feature. At operation 206, the method 200 can couple and/or adhering a first back surface of the cover layer to a first front surface of the base layer by inserting the three-dimensional feature into the opening, the three-dimensional feature extending past a plane defined by a second front surface of the cover layer. At operation 208, the method 200 can position a light fixture adjacent to a second back surface of the base layer. At operation 210, the method 200 can provide electricity to the light fixture such that an illumination of the light fixture passes through the three-dimensional feature and out at least the one or more side surfaces of the three-dimensional feature onto the second front surface of the cover layer.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method of forming a three-dimensional sign, the method comprising:
generating a base layer with a three-dimensional feature by removing material from a starting block to define the three-dimensional feature;
generating a cover layer with an opening having a shape that corresponds to the three-dimensional feature; and
coupling the cover layer to a first front surface of the base layer by inserting the three-dimensional feature into the opening, the three-dimensional feature extending past a plane defined by a second front surface of the cover layer.

2. The method of claim 1,
further including,
positioning a light fixture adjacent to a back surface of the base layer; and
providing electricity to the light fixture such that the three-dimensional feature is illuminated through the opening.

3. The method of claim 2,
wherein,
the cover layer forms an opaque layer, and illumination of the light fixture is partially blocked by the opaque layer.

4. The method of claim 3,
wherein,
the three-dimensional feature includes a side surface that extends past the plane defined by the second front surface of the cover layer; and
the illumination of the light fixture transmits out the side surface of the three-dimensional feature onto the second front surface of the cover layer.

5. The method of claim 1,
wherein,
the starting block is a single starting block; and
the method further includes generating a plurality of three-dimensional features at the first front surface of the base layer by removing the material from the single starting block with a routing machine during a single routing machine usage.

6. The method of claim 1,
wherein,
the starting block is an acrylic sheet having a thickness dimension between ¼ inch and two inches.

7. The method of claim 6,
wherein,
the acrylic sheet has a width dimension of four feet and a length dimension of eight feet.

8. The method of claim 1,
wherein,
the cover layer is formed of vinyl, aluminum, or laminated wood.

9. The method of claim 1,
wherein,
the cover layer includes a translucent or opaque paint; and
coupling the cover layer to the first front surface of the base layer includes applying the translucent or opaque paint to the first front surface at one or more locations surrounding the three-dimensional feature.

10. The method of claim 1,
wherein,
generating the base layer includes removing the material with a routing machine.

11. The method of claim 1,
wherein,
the base layer is formed of acrylic, wood, or plastic.

12. The method of claim 1,
wherein,
the three-dimensional feature includes at least one of a circular profile, a rectangular profile, a square profile, or an alphanumeric symbol profile.

13. A method of forming a three-dimensional sign, the method comprising:
generating a base layer with a three-dimensional feature by removing material from a starting block to define the three-dimensional feature;
generating a cover layer with an opening having a shape that corresponds to the three-dimensional feature;
coupling the cover layer to a first front surface of the base layer by inserting the three-dimensional feature into the opening, the three-dimensional feature extending past a plane defined by a second front surface of the cover layer;
positioning a light fixture adjacent to a back surface of the base layer; and
providing electricity to the light fixture such that the three-dimensional feature is illuminated through the opening.

14. The method of claim 13,
further including,
at least partially blocking an illumination of the light fixture with the cover layer.

15. The method of claim 14,
further including,
at least partially transmitting the illumination from the light fixture out a side surface of the three-dimensional feature onto the second front surface of the cover layer.

16. The method of claim 13,
further including,
generating a plurality of three-dimensional features at the first front surface of the base layer by removing the material with a routing machined during a single routing machine usage.

17. The method of claim 13,
wherein,
generating the base layer includes removing the material with a computer numerical control (CNC) machine.

18. The method of claim 13,
wherein,
the base layer is formed of a transparent or translucent acrylic; and
the cover layer is formed of an opaque material.

19. The method of claim 13,
wherein,
coupling the cover layer to the first front surface of the base layer includes applying an adhesive to the cover layer or the base layer to bind the cover layer to the first front surface of the base layer.

20. A method of forming a three-dimensional sign, the method comprising:
generating a base layer with a three-dimensional feature by removing material from a starting block to define the three-dimensional feature;
generating a cover layer with an opening having a shape that corresponds to the three-dimensional feature;
adhering a first back surface of the cover layer to a first front surface of the base layer by inserting the three-dimensional feature into the opening, the three-dimensional feature having one or more side surfaces extending past a plane defined by a second front surface of the cover layer;
positioning a light fixture adjacent to a second back surface of the base layer; and
providing electricity to the light fixture such that an illumination of the light fixture passes through the three-dimensional feature and out the one or more side surfaces of the three-dimensional feature onto the second front surface of the cover layer.
